(19) United States
(12) Patent Application Publication
(10) Pub. No.: US 2005/0213630 A1
(43) Pub. Date: Sep. 29, 2005

(54) Amplifying of high energy laser pulses

(75) Inventors: Michael Mielke, Orlando, FL (US); Jeff Bullington, Chuluota, FL (US)

Correspondence Address: CARR & FERRELL LLP, 2200 GENG ROAD, PALO ALTO, CA, 94303, US

(73) Assignee: Raydiance, Inc., Orlando, FL (US)

(21) Appl. No.: 11/057,868

(22) Filed: Feb. 13, 2005

Related U.S. Application Data
(63) Continuation of application No. 10/849,585, filed on May 19, 2004.
(60) Provisional application No. 60/471,972, filed on May 20, 2003.
(60) Provisional application No. 60/503,578, filed on Sep. 17, 2003.

(51) Int. Cl. H01S 3/091; H01S 3/092

(52) U.S. Cl. 372/70

(57) ABSTRACT

The present invention provides a method of amplifying a beam of laser pulses by producing an amplified collimated beam of pulses using an amplifier, spatially spreading the amplified collimated beam of pulses into an expanded beam of pulses, introducing the expanded beam of pulses into the amplifier a second time to produce a twice amplified beam of pulses, recollimating the twice amplified beam of pulses to produce a twice amplified collimated beam of pulses such that the twice amplified collimated beam of pulses is of essentially the same cross-section as the amplifier, and introducing the twice amplified collimated beam of pulses into the amplifier a third time to produce a thrice amplified collimated beam of pulses such that the re-collimated beam sweeps essentially the entire volume of the amplifier.

### REFERENCE TO RELATED APPLICATIONS

This application is a continuation patent application of U.S. patent application Ser. No. 10/849,585 filed on May 19, 2004, which claims the benefit of U.S. Provisional Patent Application Nos. 60/471,972 filed on May 20, 2003 (now abandoned) and 60/503,578 filed on Sep. 17, 2003 (now abandoned). U.S. patent application Ser. No. 10/849,585 incorporated the contents of U.S. Provisional Patent Application No. 60/539,025 filed on Jan. 13, 2004 (now abandoned) by reference. The entire content of U.S. patent application Ser. No. 10/849,585 filed on May 19, 2004 is hereby incorporated by reference.

### TECHNICAL FIELD OF THE INVENTION

The present invention relates in general to the field of light amplification and, more particularly to amplification of laser pulses.

### BACKGROUND OF THE INVENTION

Without limiting the scope of the invention, its background is described in connection with light amplification, as an example. Ablative material removal is especially useful for medical purposes, either in-vivo or on the outside surface (e.g., skin or tooth), as it is essentially non-thermal and generally painless. Ablative removal of material is generally done with a short optical pulse that is stretched amplified and then compressed. A number of types of laser amplifiers have been used for the amplification.

Machining using laser ablation can remove material by disassociate the surface atoms and melting the material. Laser ablation is efficiently done with a beam of short pulses (generally a pulse-duration of three picoseconds or less). Techniques for generating these ultra-short pulses (USP) are described, e.g., in a book entitled “Femtosecond Laser Pulses” (C. Rulliere, editor), published 1998, Springer-Verlag Berlin Heidelberg N.Y. Generally large systems, such as Ti: Sapphire, are used for generating ultra-short pulses.

The USP phenomenon was first observed in the 1970's, when it was discovered that mode-locking a broad-spectrum laser could produce ultra-short pulses. The minimum pulse duration attainable is limited by the bandwidth of the gain medium, which is inversely proportional to this minimal or Fourier-transform-limited pulse duration. Mode-locked pulses are typically very short and will spread (i.e., undergo temporal dispersion) as they traverse any medium. Subsequent pulse-compression techniques are often used to obtain USP's. Pulse dispersion can occur within the laser cavity so that compression techniques are sometimes added intra-cavity. A diffraction grating compressor is shown, e.g., in U.S. Pat. No. 5,822,097 by Tournois. Pulse dispersion can occur within the laser cavity so that compression (dispersion-compensating) techniques are sometimes added intra-cavity. When high-power pulses are desired, they are intentionally lengthened before amplification to avoid internal component optical damage. This is referred to as “Chirped Pulse Amplification” (CPA). The pulse is subsequently compressed to obtain a high peak power (pulse-energy amplification and pulse-duration compression).

A beam of high energy, ultra-short (generally sub-picosecond) laser pulses can literally vaporize any material (including steel or even diamond). Such a pulse has an energy-per-unit-area that ionizes the atoms of spot on a surface and the ionized atoms are repelled from the surface. A series of pulses can rapidly create a deep hole. Some machining applications can be done with small (e.g., 10 to 20 micron diameter) spots, but other applications need larger (e.g., 40 to 100 micron) spots. While solid-state laser systems can supply enough energy (in a form compressible to short-enough pulses) for the larger spot sizes, the efficiency of such systems has been very low (generally less than 1%), creating major heat dissipation problems, and thus requiring very expensive systems that provide only slow machining, due in part to low pulse repetition rates.

As a result, there is a need for a method to produce a beam pattern within an amplifier that is efficient, substantially eliminates heating due to amplified spontaneous emission, is smaller and less expensive than existing systems and increases machining speed.

### SUMMARY OF THE INVENTION

The present invention provides a method to produce a beam pattern within an amplifier that is efficient, substantially eliminates heating due to amplified spontaneous emission, is smaller and less expensive than existing systems and increases machining speed. For example, the present invention may operate at a wavelength such that the optical amplifier can be directly pumped by laser diodes emitting wavelengths of greater than 900 nm, further increasing the efficiency. Other embodiments may use different wavelengths. The present invention can obtain efficiencies of over 30%, in addition to lowering the size and cost of the system and greatly increasing machining speed.

More specifically, the present invention provides a method of amplifying a beam of laser pulses by producing an amplified collimated beam of pulses using an amplifier, spatially spreading the amplified collimated beam of pulses into an expanded beam of pulses, introducing the expanded beam of pulses into the amplifier a second time to produce a twice amplified beam of pulses, recollimating the twice amplified beam of pulses to produce a twice amplified collimated beam of pulses such that the twice amplified collimated beam of pulses is of essentially the same cross-section as the amplifier, and introducing the twice amplified collimated beam of pulses into the amplifier a third time to produce a thrice amplified collimated beam of pulses such that the re-collimated beam sweeps essentially the entire volume of the amplifier. The amplifier is typically an optically pumped amplifier, such as a solid-state laser or a Cr⁴⁺:YAG disc array.

The amplified collimated beam of pulses may be produced by inputting an essentially collimated input beam of laser pulses axially into a center portion of the amplifier. Additionally, the amplifier may be pumped by laser diodes with an emission wavelength of greater than 900 nm. The amplified re-collimated beam can then be used in laser ablation.

The beam expansion is preferably be preformed by a convex mirror; but, the beam expansion may be preformed by a lens or a flat mirror. The recollimation may be done by a concave mirror. The axial input of the input beam may be done through a hole in the concave mirror. The convex mirror may be essentially the same size as the hole in the concave mirror. Moreover, the method of amplifying a beam of laser pulses may be repeated to amplify the thrice amplified collimated beam of pulses one or more times to produce a 4^{th}, 5^{th}, 6^{th}, and so on amplified collimated beam of pulses. As a result, the method may be repeated as many times as necessary to yield the desired amplified collimated beam of pulses.

In addition, the present invention provides a method of amplifying a beam of laser pulses by spatially spreading a collimated beam of pulses to produce expanding beam of pulses, introducing the expanding beam of pulses into an optically pumped optical amplifier to produce an amplified of beam of pulses, re-collimating the amplified of beam of pulses to produce a collimated beam of amplified pulses, wherein the collimated beam of amplified pulses are of essentially the same cross-section as the optically pumped optical amplifier and introducing the collimated beam of amplified pulses into the optically pumped optical amplifier to produce a collimated beam of twice amplified pulses. The spatially spreading may be done by inputting a collimated beam into a spatially spreading lens.

### BRIEF DESCRIPTION OF THE DRAWINGS

For a more complete understanding of the features and advantages of the present invention, reference is now made to the detailed description of the invention along with the accompanying figures and in which:

FIG. 1 illustrates a sectional elevation of a three-pass optical amplifier in accordance with the present invention.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a,” “an” and “the” are not intended to refer to only a singular entity, but include the general class of which a specific example may be used for illustration. The terminology herein is used to describe specific embodiments of the invention, but their usage does not delimit the invention, except as outlined in the claims.

The present invention provides a method to produce a beam pattern within an amplifier that is efficient, substantially eliminates heating due to amplified spontaneous emission, is smaller and less expensive than existing systems and increases machining speed. For example, the present invention may operate at a wavelength such that the optical amplifier can be directly pumped by laser diodes emitting wavelengths of greater than 900 nm, further increasing the efficiency. Other embodiments may use different wavelengths. The present invention can obtain efficiencies of over 30%, in addition to lowering the size and cost of the system and greatly increasing machining speed.

More specifically, the present invention provides a method of amplifying a beam of laser pulses by producing an amplified collimated beam of pulses using an amplifier, spatially spreading the amplified collimated beam of pulses into an expanded beam of pulses, introducing the expanded beam of pulses into the amplifier a second time to produce a twice amplified beam of pulses, recollimating the twice amplified beam of pulses to produce a twice amplified collimated beam of pulses such that the twice amplified collimated beam of pulses is of essentially the same cross-section as the amplifier, and introducing the twice amplified collimated beam of pulses into the amplifier a third time to produce a thrice amplified collimated beam of pulses such that the re-collimated beam sweeps essentially the entire volume of the amplifier. The amplifier is typically an optically pumped amplifier, such as a solid-state laser or a Cr⁴⁺:YAG disc array.

The amplified collimated beam of pulses may be produced by inputting an essentially collimated input beam of laser pulses axially into a center portion of the amplifier. Additionally, the amplifier may be pumped by laser diodes with an emission wavelength of greater than 900 nm. The amplified re-collimated beam can then be used in laser ablation.

The beam expansion is preferably be preformed by a convex mirror; but, the beam expansion may be preformed by a lens or a flat mirror. The recollimation may be done by a concave mirror. The axial input of the input beam may be done through a hole in the concave mirror. The convex mirror may be essentially the same size as the hole in the concave mirror. Moreover, the method of amplifying a beam of laser pulses may be repeated to amplify the thrice amplified collimated beam of pulses one or more times to produce a 4^{th}, 5^{th}, 6^{th}, and so on amplified collimated beam of pulses. As a result, the method may be repeated as many times as necessary to yield the desired amplified collimated beam of pulses.

In addition, the present invention provides a method of amplifying a beam of laser pulses by spatially spreading a collimated beam of pulses to produce expanding beam of pulses, introducing the expanding beam of pulses into an optically pumped optical amplifier to produce an amplified of beam of pulses, re-collimating the amplified of beam of pulses to produce a collimated beam of amplified pulses, wherein the collimated beam of amplified pulses are of essentially the same cross-section as the optically pumped optical amplifier and introducing the collimated beam of amplified pulses into the optically pumped optical amplifier to produce a collimated beam of twice amplified pulses. The spatially spreading may be done by inputting a collimated beam into a spatially spreading lens.

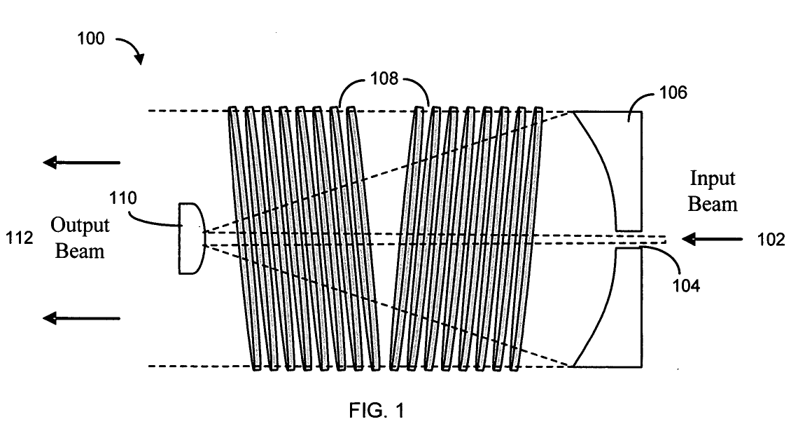

Now referring to FIG. 1, a sectional elevation of a three-pass optical amplifier 100 in accordance with the present invention is shown. The multi-pass configuration of the present invention may include unstable resonator that offers a number of advantages in the operation of high power optical amplifiers. The input beam 102 is small and passes through a hole 104 in the concave mirror 106 that is on the axial centerline of the amplifier array 108. In some embodiments the amplifier array 108 may be one or more Cr⁴⁺:YAG disc arrays. The input beam 102 is amplified by the initial pass and is subsequently reflected and spread by a convex mirror 110 (not shown to scale, enlarged to illustrate convex surface). In some embodiments, the convex mirror 110 may be about the same size as the hole 104. The divergent beam passes back through the amplifier array 108 where it is again amplified and then collimated by concave mirror 106. The collimated beam passes a final time through the amplifier array 108 where it reaches the saturation fluence level of the entire amplifier array 108 and exits the cavity 100 as output beam 112. In some embodiments, the collimated beam exiting the small convex mirror 110.

Each pass through the amplifier array 108 amplifies the beam energy. In some embodiments, the amplifier array 108 may be a Cr⁴⁺:YAG, wherein the saturation energy density per unit area of the Cr⁴⁺:YAG is about 0.5 J/cm². Beam divergence improves gain extraction efficiency, reduces amplified spontaneous emission (ASE) noise, and permits high optical power without damage to the crystals or cavity mirrors.

In another embodiment (not shown), the beam diverging convex mirror 106 is set at an angle. The angle may be 45 degrees, however other embodiments may use different angles depending on the configuration. In some embodiments, the input beam 102 enters vertically from above the convex mirror 106. However, in other embodiments the input beam 102 enters through a hole 104 in the concave mirror 106. In alternate embodiments, the beam (not shown) is diverged and sent to the concave mirror 106 where it is collimated and sent back through the amplifier array 108, thus being a two-pass arrangement.

Generally, the pumping power and timing between pulses are controlled such that pumping does not saturate the disc array and thus ASE is reduced.

The present invention may be used in systems along with the co-owned and previously filed provisional applications noted below by docket number, title and (generally) provisional number, and are hereby incorporated by reference herein:

| Docket | | US Ser. | |
|---|---|---|---|
| Number | Title | No. | Filing Date |
| ABI-1 | Laser Machining | 60/471,922 | May 20, 2003 |
| ABI-2 | Laser Contact With W/Dopant/Copper Alloy | 60/472,070 | May 20, 2003 |
| ABI-3 | SOAs Electrically And Optically In Series | 60/471,913 | May 20, 2003 |
| ABI-4 | Camera Containing Medical Tool | 60/472,071 | May 20, 2003 |
| ABI-5 | In-vivo Tool with Sonic Locator | 60/471,921 | May 20, 2003 |
| ABI-6 | Scanned Small Spot Ablation With A High-Rep- | 60/471,972 | May 20, 2003 |
| | Rate | | |
| ABI-7 | Stretched Optical Pulse Amplification and | 60/471,971 | May 20, 2003 |
| | Compression | | |
| ABI-8 | Controlling Repetition Rate Of Fiber Amplifier | 60/494,102 | Aug. 11, 2003 |
| ABI-9 | Controlling Pulse Energy Of A Fiber Amplifier By | 60/494,275 | Aug. 11, 2003 |
| | Controlling Pump Diode Current | | |
| ABI-10 | Pulse Energy Adjustment For Changes In Ablation | 60/494,274 | Aug. 11, 2003 |
| | Spot Size | | |
| ABI-11 | Ablative Material Removal With A Preset | 60/494,273 | Aug. 11, 2003 |
| | Removal Rate or Volume or Depth | | |
| ABI-12 | Fiber Amplifier With A Time Between Pulses Of | 60/494,272 | Aug. 11, 2003 |
| | A Fraction Of The Storage Lifetime | | |
| ABI-13 | Man-Portable Optical Ablation System | 60/494,321 | Aug. 11, 2003 |
| ABI-14 | Controlling Temperature Of A Fiber Amplifier By | 60/494,322 | Aug. 11, 2003 |
| | Controlling Pump Diode Current | | |
| ABI-15 | Altering The Emission Of An Ablation Beam for | 60/494,267 | Aug. 11, 2003 |
| | Safety or Control | | |
| ABI-16 | Enabling Or Blocking The Emission Of An | 60/494,172 | Aug. 11, 2003 |
| | Ablation Beam Based On Color Of Target Area | | |
| ABI-17 | Remotely-Controlled Ablation of Surfaces | 60/494,276 | Aug. 11, 2003 |
| ABI-18 | Ablation Of A Custom Shaped Area | 60/494,180 | Aug. 11, 2003 |
| ABI-19 | High-Power-Optical-Amplifier Using A Number | 60/497,404 | Aug. 22, 2003 |
| | Of Spaced, Thin Slabs | | |
| ABI-20 | Spiral-Laser On-A-Disc | 60/502,879 | Sep. 12, 2003 |
| ABI-21 | Laser Beam Propagation in Air | 60/502.886 | Sep. 12, 2003 |
| ABI-22 | Active Optical Compressor | 60/503,659 | Sep. 17, 2003 |
| ABI-23 | Controlling Optically-Pumped Optical Pulse | 60/503,578 | Sep. 17, 2003 |
| | Amplifiers | | |
| ABI-24 | High Power SuperMode Laser Amplifier | 60/505,968 | Sep. 25, 2003 |
| ABI-25 | Semiconductor Manufacturing Using Optical | 60/508,136 | Oct. 02, 2003 |
| | Ablation | | |
| ABI-26 | Composite Cutting With Optical Ablation | 60/510,855 | Oct. 14, 2003 |
| | Technique | | |
| ABI-27 | Material Composition Analysis Using Optical | 60/512,807 | Oct. 20, 2003 |
| | Ablation | | |
| ABI-28 | Quasi-Continuous Current in Optical Pulse | 60/529,425 | Dec. 12, 2003 |
| | Amplifier Systems | | |
| ABI-29 | Optical Pulse Stretching and Compression | 60/529,443 | Dec. 11, 2003 |
| ABI-30 | Start-Up Timing for Optical Ablation System | 60/539,926 | Jan. 23, 2004 |
| ABI-31 | High-Frequency Ring Oscillator | 60/539,924 | Jan. 23, 2004 |
| ABI-32 | Amplifying of High Energy Laser Pulses | 60/539,925 | Jan. 23, 2004 |
| ABI-33 | Semiconductor-Type Processing for Solid State | 60/543,086 | Feb. 09, 2004 |
| | Lasers | | |
| ABI-34 | Pulse Streaming of Optically-Pumped Amplifiers | 60/546,065 | Feb. 18, 2004 |
| ABI-35 | Pumping of Optically-Pumped Amplifiers | 60/548,216 | Feb. 27, 2004 |

Although the present invention and its advantages have been described above, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification, but only by the claims.

1. A method of amplifying a beam of laser pulses, comprising the steps of:
producing an amplified collimated beam of pulses using an amplifier;
spatially spreading the amplified collimated beam of pulses into an expanded beam of pulses;
introducing the expanded beam of pulses into the amplifier a second time to produce a twice amplified beam of pulses;
recollimating the twice amplified beam of pulses to produce a twice amplified collimated beam of pulses, whereby the twice amplified collimated beam of pulses is of essentially the same cross-section as the amplifier; and
introducing the twice amplified collimated beam of pulses into the amplifier a third time to produce a thrice amplified collimated beam of pulses, whereby the recollimated beam sweeps essentially the entire volume of the amplifier.

2. The method of claim 1, wherein the amplified collimated beam of pulses is produced by inputting an essentially collimated input beam of laser pulses axially into a center portion of an optically pumped amplifier.

3. The method of claim 1, wherein the amplifier is an optically pumped optical amplifier.

4. The method of claim 3, wherein the optically pumped optical amplifier is pumped by one or more laser diodes with an emission wavelength of greater than about 900 nm.

5. The method of claim 3, wherein the optically pumped optical amplifier is a solid-state laser or a Cr⁴⁺:YAG disc array.

6. The method of claim 1, wherein the method increases efficiency and substantially eliminates amplified spontaneous emission.

7. The method of claim 1, wherein the thrice amplified collimated beam of pulses is used in laser ablation.

8. The method of claim 1, wherein the spatially spreading is done by a convex mirror.

9. The method of claim 1, wherein the recollimating is done by a concave mirror.

10. The method of claim 2, wherein the axial input of the input beam is done through a hole in a concave mirror.

11. The method of claim 10, wherein the spatially spreading is done by a convex mirror and the convex mirror is essentially the same size as the hole in the concave mirror.

12. The method of claim 1, further comprising the step of amplifying the thrice amplified collimated beam of pulses one or more additional times.

13. A method of amplifying a beam of laser pulses, comprising the steps of:
spatially spreading a collimated beam of pulses to produce expanding beam of pulses;
introducing the expanding beam of pulses into an optically pumped optical amplifier to produce an amplified of beam of pulses;
re-collimating the amplified of beam of pulses to produce a collimated beam of amplified pulses, wherein the collimated beam of amplified pulses are of essentially the same cross-section as the optically pumped optical amplifier; and
introducing the collimated beam of amplified pulses into the optically pumped optical amplifier to produce a collimated beam of twice amplified pulses.

14. The method of claim 13, wherein the spatially spreading is done by inputting a collimated beam into a spatially spreading lens.
